(19) United States
(12) Patent Application Publication
(10) Pub. No.: US 2019/0109473 A1
(43) Pub. Date: Apr. 11, 2019

(54) OUTPUT ARRANGEMENT FOR THE OUTPUT OF A MOBILE COMMUNICATION UNIT, AND A METHOD FOR CHARGING A STORAGE ELEMENT OF A MOBILE COMMUNICATION UNIT

(71) Applicant: Pyramid Computer GmbH, Freiburg (DE)

(72) Inventor: Friedrich Hansen, Freiburg (DE)

(73) Assignee: Pyramid Computer GmbH, Freiburg (DE)

(21) Appl. No.: 16/089,045

(22) PCT Filed: Mar. 16, 2017
(86) PCT No.: PCT/EP2017/000346

§ 371 Date: Sep. 27, 2018

(30) Foreign Application Priority Data
Apr. 8, 2016 (DE) 10 2016 004 068.8

(51) Int. Cl. H02J 7/00; H02J 7/02

(52) U.S. Cl. CPC H02J 7/0042; H02J 7/025; H02J 7/0027

(57) ABSTRACT

An output arrangement (1) for issuing a mobile communication unit (2) from a storage unit (3), in which a supply of a plurality of mobile communication units (2) can be or are stored. The output arrangement (1) has a return device (4) for returning a mobile communication unit (2) into the storage unit (3), a charging device (5) for charging a rechargeable storage element of a mobile communication unit (2), and an output device (6) for issuing respectively one mobile communication unit (2) from the store. The output arrangement (1) is set up in such a way that the output device is set up to issue mobile communication units (2) in an order in which the mobile communication units have been placed into the storage unit (3) via the return device (4).

### BACKGROUND

The invention relates to an output arrangement for issuing a mobile communication unit from a storage unit, in which a supply of a plurality of mobile communication units can be or are stored.

Furthermore, the invention also concerns a method to charge a rechargeable storage element of a mobile communication unit in a supply of a plurality of mobile communication units.

Output arrangements and methods of the aforementioned type are already known. Frequently, previously known output arrangements are designed in such a way that a mobile communication unit, which has last been returned into a storage unit of the output arrangement, is taken out again as the first out of the supply (i.e. “last in-first out”).

Mobile communication units, as have been provided in the case of the output arrangement of the previously mentioned type, are used in the restaurant and catering field, for example. When placing an order, such a mobile communication unit is handed to the guest. Then, by means of the mobile communication unit, the guest is informed when his/her order is ready to be picked up at a location designated therefor via a radio connection.

During the course of developing such systems, improved systems arose where a localization of the mobile communication units is made possible within a network infrastructure in order to be able to determine a seating area of the guest and be able to deliver his/her order to him/her. However, such mobile communication units require their own energy source and therefore, they generally comprise a rechargeable storage element, such as a rechargeable battery, for example.

A charging of these rechargeable storage elements has generally taken place manually up to this point or, in the case of charging these storage elements, previously known output arrangements have the disadvantage that a charging cycle of a storage element of a mobile communication unit in the supply of the output arrangement can be too short for enabling adequate or, in particular, full charging to take place.

### SUMMARY

Therefore, the object of the invention is to create an output arrangement and/or a method of the aforementioned type, wherein aforementioned problems are eliminated.

In order to achieve this object, one or more features according to the invention are provided. In particular, in order to achieve the mentioned task according to the invention, in the case of an output arrangement of the aforementioned type, it is provided that the output arrangement comprises a return device for returning a mobile communication unit into the storage unit, a charging device for charging a rechargeable storage element of a mobile communication unit and an output device for issuing respectively one mobile communication unit from the supply, and that the output arrangement is set up in such a way that the output device is set up to issue mobile communication units in an order in which they entered into the storage unit via the return device (i.e. “first in-first out”). By this output arrangement according to the invention, it is therefore possible to charge a storage element of a mobile communication unit during its storage within the output arrangement before this is given out again to a user. The available charging time is thereby increased since the communication unit that has been last returned is not removed again as the first one from a supply of a plurality of mobile communication units if it is given out again to another user, but, beforehand, all the mobile communication units present within the existing supply at this time are given out before the returned mobile communication unit.

In accordance with a particularly favorable embodiment of the output arrangement according to the invention, it can be provided that the storage unit defines a transport route, in particular, one that is shaped like a shaft. Thereby, it can be particularly expedient if the return device is arranged at its upper end and the device to be taken out is arranged at its lower end. The embodiment of the transport route of the storage unit, in particular as a shaft, can have the advantage that the mobile communication units rest on one another in a particularly space-saving manner and/or can be stored or are stored in a defined order.

As an alternative or in addition to this, in accordance with a particularly favorable embodiment according to the invention, it can be provided that the mobile communication units can be charged or are charged by the charging device within the storage unit, in particular in two, three, four or more charging sections. By means of this, an unnecessary removal and refilling of the storage unit in a manual step can be prevented.

In order to prevent misuse by a user and/or in order to be able to devise a return of a mobile communication unit in the simplest way possible, it can be expedient if the return device comprises a return means, in particular, a return means that is pivotably mounted around a rotational axis and/or designed at least in sections as a hollow cylinder or as part of a hollow cylinder, having a return compartment to hold a mobile communication unit, into which return compartment a mobile communication unit can be inserted by a user. Thereby, it can be particularly expedient if the return device comprises a drive unit, by which a or the return means can be moved, in particular, rotated around a rotational axis or the one that has already been mentioned. Preferably, the drive unit can be a servo.

In order to charge a plurality of mobile communication units stored in the supply, it can be expedient if the charging device comprises a plurality of charging stations, which are arranged on an outer side of the storage unit and/or between the return device and the output device and/or are connected to a storage space of the storage unit, whereby, at the same time, a charging of a plurality of mobile communication units located in the storage unit, in particular in a charging section, is enabled. In particular, by this, it can be achieved that all mobile communication units located in the storage unit and/or in the charging sections can be charged. A particularly favorable embodiment of the output arrangement according to the invention can here be set up in such a way that each mobile communication unit in the storage unit or at least in a partial area with charging sections of the storage unit, in particular in the section of the charging device, is assigned to or can be assigned to precisely one charging section, each having a charging station. By this, it is possible that the rechargeable storage element of a mobile communication unit, which, due to the issuance of another mobile communication unit, has been passed a position in another charging section within the supply, can also be charged in this position. As an alternative or in addition, it can therefore be expedient if the charging device is set up to resume a charging cycle for a mobile communication unit, which began at a previous charging station.

To be able to avoid a charging needing to take place via outwardly oriented electronic contacts of a mobile communication unit, it can be expedient if the mobile communication units can be charged by the charging stations in a wireless manner, in particular, by inductive energy transfer by electromagnetic induction (Qi). Furthermore, by this, a reliable charging of the storage elements of the mobile communication units can be ensured since it is not required to bring the mobile communication units into a certain position in order to establish a connection between electrical contact elements, by which a charging can occur.

As an alternative or in addition to this, according to the invention, it can be provided that the charging stations of the charging devices each comprise at least one sender coil and the mobile communication units each comprise at least one receiver coil. By this, an energy transmission is possible from the sender coil to the receiver coil.

It can be expedient if the return device, the charging device and the output device are each composed of a replaceable module. By this, the maintenance and replacement of defective components of the output arrangement according to the invention is made considerably easier.

As an alternative or in addition, it can furthermore be expedient if the storage unit is formed by the return device, the charging device and the output device. Furthermore it can be expedient if the charging device comprises at least one, in particular two, direct-current converters.

In order to be able to prevent an undesired output of a mobile communication unit, in the case of the output arrangement according to the invention, it can be provided that the output device comprises a blocking device to retain the mobile communication units before being given out to a user into an output compartment and/or an output region. The blocking device can be moved between a closed position and an open position. Thereby, it can be particularly expedient if a movement takes place between a closed and an open position by a drive unit. In accordance with a particularly favorable embodiment of the invention, the blocking device can be designed as a rocker. Preferably, the drive unit can be designed as a servo.

In addition to this, the blocking device can comprise a blocking element that is pivotably mounted around a rotational axis, wherein the blocking device is in a closed position if an end of the blocking element facing an output opening is inclined in the direction of the storage unit and that the blocking device is in an open position if an end of the blocking element facing away from the output opening is inclined in the direction of the storage unit. As an alternative or in addition, it can be provided that a length of one or of the blocking element is greater than or identical to a greatest extent of a mobile communication unit.

In accordance with a particularly favorable embodiment of the output arrangement according to the invention, it can be provided that this comprises a registration device, by which a mobile communication unit can be assigned to a user. It can be particularly favorable if the mobile communication unit is designed as a sender and/or as a receiver unit, preferably as a bidirectional sender and/or receiver unit. Furthermore, it can also be expedient if the output arrangement according to the invention comprises a network infrastructure, via which the mobile communication unit can be addressed and the mobile communication unit allows for a localization to take place at least within the previously mentioned network infrastructure.

In order to improve the hygiene of the mobile communication units issued by the output station, it can be expedient if the output arrangement comprises a cleaning device, by which a mobile communication unit can be cleaned, in particular, within the storage unit. Furthermore, it can be expedient if the mobile communication units of the output arrangement according to the invention are designed in a waterproof manner and/or without outwardly oriented physical contact elements.

Furthermore, in order to achieve the object mentioned at the outset, a method of the type mentioned at the outset is provided with the one or more features of the invention. In particular, according to the invention, in order to achieve the mentioned object, it can be provided that the mobile communication unit is returned to the supply in a return step, then, the mobile communication unit is conveyed into a first charging section and a rechargeable storage element of the mobile communication unit is charged in a charging step, wherein, when removing at least one other mobile communication unit from the supply, which has already been in the supply for a longer period of time, this communication unit is passed on out of the first charging section, preferably by precisely one charging section per output mobile communication unit within the supply and then the storage element is transferred into at least one second charging section and the storage element is further charged in this at least one second charging section. Thereby, the second charging section must not mandatorily be a charging section lying the closest to the first charging section spatially, but can also be spatially after a charging section lying closest. For example, this can be the case if a plurality of mobile communication units are issued at the same time or one after another in brief succession. In particular, the charging cycle can last until this mobile communication unit is conveyed out of a charging region, in particular, a charging region, which comprises the charging sections, of the supply, and/or is issued from the supply and/or until the storage element is completely charged.

Another feature according to the invention can provide that the communication unit returned during the return step is the last that is issued from the supply that exists at this point in time in an output step.

As an alternative or in addition, it can furthermore be expedient if the mobile communication units are issued from the supply in an order specified by a temporal sequence of the return steps.

The output arrangement according to the invention, as it is described and claimed herein, is particularly appropriate for executing the method described and claimed herein according to the invention.

### BRIEF DESCRIPTION OF THE DRAWINGS

The invention is now explained in more detail based on the exemplary embodiment; however, it is not limited to this exemplary embodiment. Other exemplary embodiments result from the combination of the features of individual or a plurality of claims among each other and/or with individual or a plurality of features of the exemplary embodiments.

The figures show:

FIG. 1 an embodiment of the output arrangement according to the invention in a lateral view, wherein the region of a return device is shown,

FIG. 2 the area in accordance with FIG. 1 in a top view,

FIG. 3 a region of a charging device of the output arrangement according to the invention in accordance with FIGS. 1 and 2 in a top view,

FIG. 4 the area of the output arrangement according to the invention in a lateral view in accordance with FIG. 3,

FIG. 5 a region of an output device of the output arrangement according to the invention in accordance with FIG. 1 to FIG. 4 in a lateral view, and

FIG. 6 the area of the output arrangement according to the invention in a top view in accordance with FIG. 5.

### DETAILED DESCRIPTION

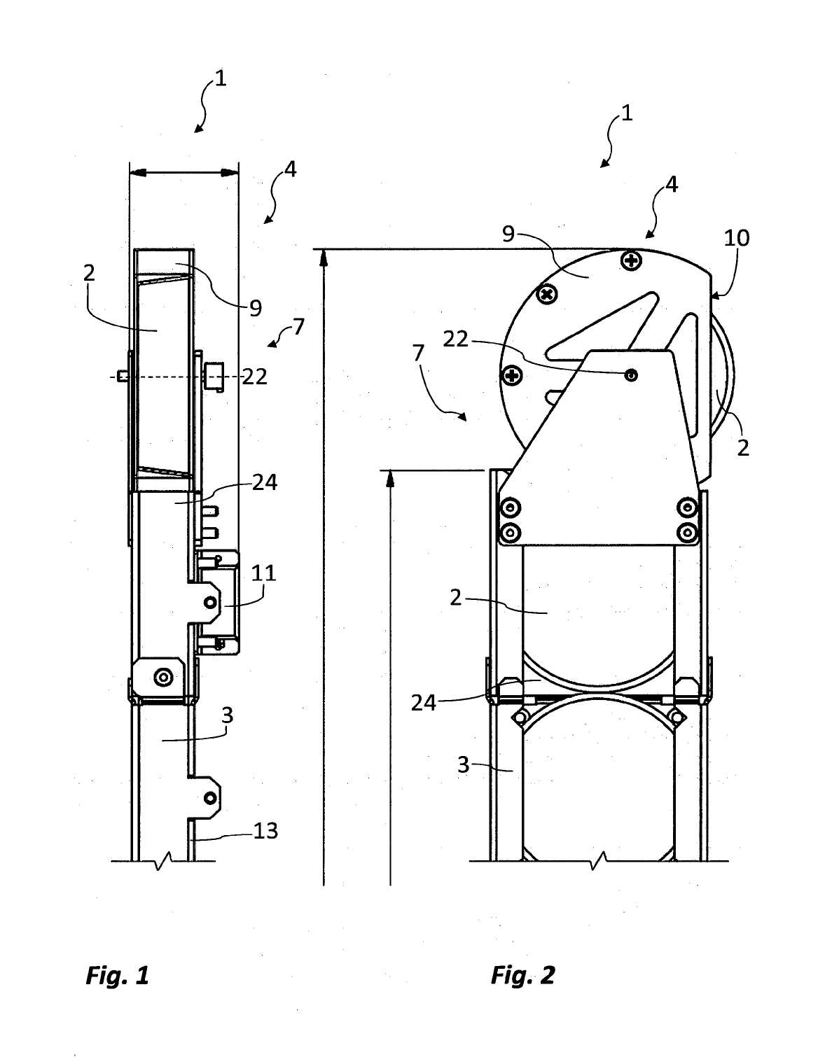

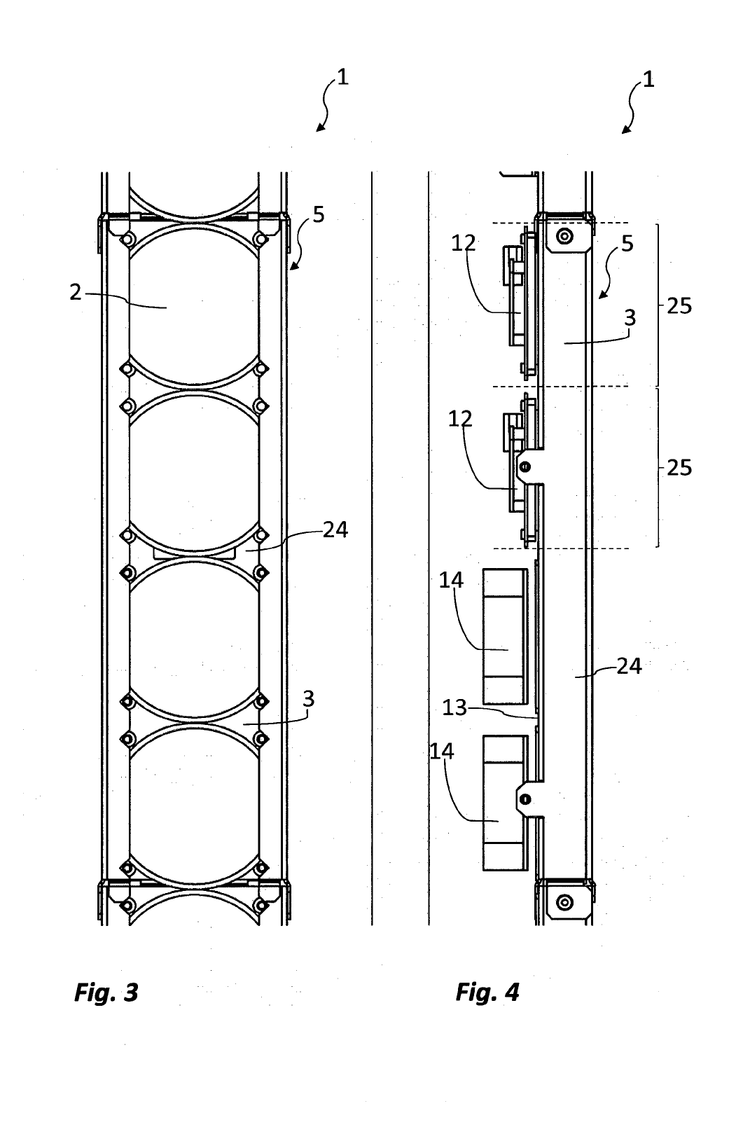

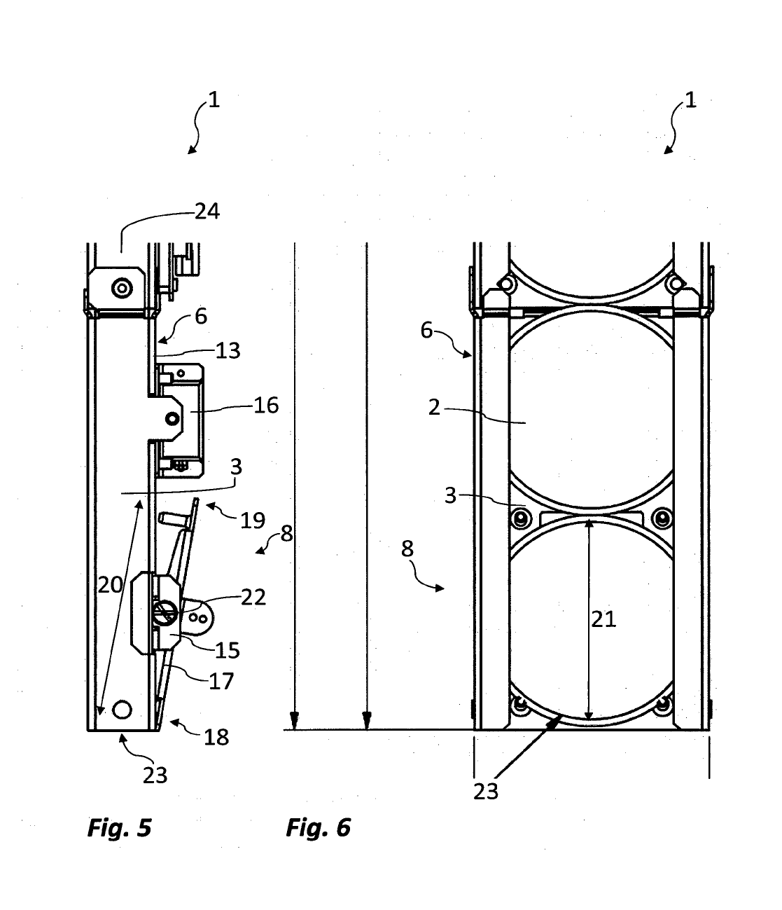

FIGS. 1 to 6 show various partial sections of an output arrangement 1 according to the invention. In FIGS. 1 and 2, the region of the return device 4, in FIGS. 3 and 4 the region of a charging device 5 and in FIGS. 5 and 6, the region of an output device 6 is shown.

The output arrangement 1 comprises a storage unit 3 and is set up to issue a mobile communication unit 2 from a supply stored in the storage unit 3 consisting of a plurality of mobile communication units 2. The mobile communication units 2 can be stored or are stored within the storage unit 3 in a storage space 24.

The return device 4 of the output arrangement 1 is set up to return a mobile communication unit into the storage unit 3. The charging device 5 is set up to charge a rechargeable storage element of a mobile communication unit 2. The output device 6 is set up to issue one mobile communication unit 2 from the supply respectively. Here, it is provided that a mobile communication unit 2 returned via the return device 4 is the last that is given out to a user from the supply that exists at this point in time. The older inventory of mobile communication units 2 which was stored initially is therefore given out first before the last returned mobile communication unit 2 is given out again.

The storage unit 3 is shaped like a shaft, at the upper end 7 of which the return device 4 is arranged and at the lower end of which 8 the output device 6 is arranged. Within the shaft, the mobile communication units 2 can be stored or are stored in such a way that they rest on one another. By this, particularly space-saving storage is possible.

As can be seen in FIG. 1, the return device 4 comprises a return means 9, which is at least partially designed as a hollow cylinder, in particular, as a cut-up hollow cylinder, and is pivotably mounted around a rotational axis 22. The return means 9 furthermore comprises a return compartment 10, which is formed by a hollow space and is set up to hold a mobile communication unit 2. Therefore, a user can insert a mobile communication unit 2 into the return compartment 10 in an easy manner. The return device 4 furthermore comprises a drive unit 11, by which the return means 9 can be rotated around the rotational axis 22. In particular, by this, a rotation out of an insertion position, in which a user can insert a mobile communication unit 2 into the return compartment 10, into a supply position, in which the mobile communication unit 2 can be added to the supply again or vice versa can take place.

The charging device 5 is shown in FIGS. 3 and 4. This charging device 5 comprises a plurality of charging stations 12, which are arranged on an outer side 13 of the storage unit 3 between the return device 4 and the output device 6. Each charging station 12 is assigned or can be assigned to a charging section 25 within the storage unit 3. By this, it can be ensured that a charging of the rechargeable storage unit of a mobile communication unit 2 can also be carried out in the case of issuing one or a plurality of other mobile communication units 2 from the supply while this mobile communication unit 2 is always in a charging section 25 and is able to be charged in it or is charged in it, as long as it is in a region of the storage unit 3 with a plurality of charging sections 25. The number of charging sections 25 is therefore determined by the number of charging stations 12 of the charging device 5. It is particularly expedient if the storage unit 3 comprises charging sections 25 across its entire length. By this, all of the mobile communication units 2 located in the supply can be charged at the same time. It can be expedient if the output arrangement 1 comprises three, four, five, six or more charging sections 25.

The charging stations 12 comprise a sender coil and the mobile communication units 2 each comprise a receiver coil. By this, a wireless charging of the rechargeable storage elements is possible, in particular by inductive energy transfer (Qi). The output arrangement 1 according to the invention comprises at least one, and particularly two, direct-current converter(s).

The output device 6 is shown in FIGS. 5 and 6. The output device 6 comprises a blocking device 15 to retain the mobile communication units 2 before being issued to a user, for example, in an output compartment and/or an output region. The blocking device 15 is designed as a rocker, as is shown in FIGS. 5 and 6. The blocking device 15 therefore has a blocking element 17 rotatably mounted around a rotational axis 22. By activation of the drive unit 16, the blocking unit 17 can be moved between a closed position and an open position. In the case of the embodiment shown, a closed position then occurs if an end 18 of the blocking element 17 facing an output opening 23 is inclined in the direction of the storage unit 3. An open position of the blocking element 17 then occurs if an end 19 of the blocking element 17 facing away from the output opening 23 is inclined in the direction of the storage unit 3.

In order to ensure an adequate output of only one mobile communication unit respectively by means of the output device 6, a length 20 of the blocking element 17 is greater than or identical to the greatest extent 21 of the mobile communication units 2.

### REFERENCE LIST

1 output arrangement
2 mobile communication unit
3 storage unit
4 return device
5 charging device
6 output device
7 upper end of the storage unit 3
8 lower end of the storage unit 3
9 return means
10 return compartment
11 drive unit of the return device 4
12 charging station
13 outer side of the storage unit 3
14 direct-current converter
15 locking device
16 drive unit of the blocking device 15
17 locking element
18 the end of the blocking element 17 facing the output opening 23
19 the end of the blocking element 17 facing away from the output opening 23
20 length of the blocking element 17
21 largest extent of a mobile communication unit 2
22 rotational axis of the return means 9
23 output opening
24 storage space of the storage unit 3
25 charging section

1. An output arrangement (1) for issuing a mobile communication unit (2), the output arrangement comprising:
a storage unit (3), in which a supply of a plurality of mobile communication units (2) are adapted to be store;
a return device (4) adapted for returning the mobile communication unit (2) into the storage unit (3),
a charging device (5) adapted for charging a rechargeable storage element of the mobile communication unit (2); and
an output device (6) adapted to issue respectively one of the mobile communication units (2) from the supply, and wherein the output device is set up to issue mobile communication units (2), in an order in which they entered the storage unit (3) via the return device (4).

2. The output arrangement (1) as claimed in claim 1, wherein the storage unit (3) defines a transport route, the return device (4) is arranged at an upper end (7) of the transport route and the output device (6) is arranged at a lower end (8) of the transport route, such that the mobile communication units (2) are adapted to be stored in a defined order.

3. The output arrangement (1) as claimed in claim 1, wherein the return device (4) comprises a return carrier (9) that is pivotably mounted around a rotational axis (22) having a return compartment (10) to hold a mobile communication unit (2), into which a mobile communication unit (2) is adapted to be by a user.

4. The output arrangement (1) as claimed in claim 1, wherein the charging device (5) comprises a plurality of charging stations (12), which are arranged at least one of on an outer side (13) of the storage unit (3), between the return device (4) and the output device (6), or connected to a storage space (24) of the storage unit (3), in order to enable, at the same time, a charging of a plurality of the mobile communication units (2) located at least one of within the storage unit (3) or within the charging sections (25).

5. The output arrangement (1) as claimed in claim 1, wherein the charging device (5) comprises a plurality of charging stations (12), and the mobile communication units (2) are adapted to be charged by the charging stations (12) in a wireless manner.

6. The output arrangement (1) as claimed in claim 1, wherein the return device (4), the charging device (5), and the output device (6) are each comprised of a replaceable module.

7. The output arrangement (1) as claimed in claim 1, wherein the output device (6) comprises a blocking device (15) that is adapted to retain the mobile communication units (2) before being issued to a user into at least one of an output compartment or an output region, which is movable between a closed position and an open position.

8. The output arrangement (1) as claimed in claim 7, wherein the blocking device (15) comprises a blocking element (17) that is pivotably mounted around a rotational axis (22), the blocking device (15) is in [[a]] the closed position if an end (18) of the blocking element (17) facing an output opening (23) is inclined in a direction of the storage unit (3) and in that the blocking device (15) is in the open position if an end (19) of the blocking element (17) facing away from the output opening (23) is inclined in the direction of the storage unit (3) and a length (20) of the blocking element (17) is adapted to be greater than or identical to a greatest extent (21) of a mobile communication unit (2).

9. The output arrangement (1) as claimed in claim 1, further comprising a registration device, by which a mobile communication unit (2) is adapted to be assigned to a user, wherein the mobile communication unit (2) is designed as at least one of a sender unit or a receiver unit, and a network infrastructure, via which the mobile communication unit (2) is adapted to be addressed and the mobile communication unit (2) allows a localization to take place at least within the network infrastructure.

10. The output arrangement (1) as claimed in claim 1, further comprising a cleaning device, with which a mobile communication unit (2) is adapted to be cleaned.

11. A method for charging a rechargeable storage element of a mobile communication unit (2) in a supply that includes a plurality of mobile communication units (2), the method comprising:
returning the mobile communication unit (2) to the supply in a return step;
conveying the mobile communication unit (2) returned in the return step into a first charging section (25);
recharging a rechargeable storage element of the returned mobile communication unit (2) in a charging step; and
when removing at least one other of the communication units (2) from the supply, which has already been in the supply for a longer period of time, passing said mobile communication unit (2) that was returned in the return step out of the first charging section into at least one second charging section and then further charging the rechargeable storage element in said at least one second charging section.

12. The method as claimed in claim 11, further comprising at least one of issuing the communication unit (2) returned during the return step as a last of the mobile communication units (2) that is issued from the supply that exists at this point in time in an output step, or issuing the mobile communication units (2) from the supply in an order specified by a temporal sequence of the return steps.

13. The method as claimed in claim 11, wherein, wherein the method is carried out with an output arrangement (1) that comprises: a storage unit (3), in which the mobile communication units (2) are stored, a return device (4) for returning the mobile communication unit (2) into the storage unit (3), a charging device (5) for charging the rechargeable storage elements of the mobile communication unit (2), and an output device (6) that issues respectively one of the mobile communication units (2) from the supply, and wherein the output device is set up to issue mobile communication units (2), in an order in which they entered the storage unit (3) via the return device (4).

14. The output arrangement (1) as claimed in claim 1, wherein the charging device (5) includes in two or more charging sections (25), and the mobile communication units (2) are adapted to be charged by the charging device (5) within the storage unit (3), in the two or more charging sections (25).

15. The output arrangement (1) as claimed in claim 3, wherein the return carrier (9) is formed at least in sections as at least a part of a hollow cylinder.

16. The output arrangement (1) as claimed in claim 3, wherein the return device (4) comprises a drive unit (11), by which the return carrier (9) is rotatable around the rotational axis (22).

17. The output arrangement (1) as claimed in claim 4, wherein the plurality of charging stations (12) are arranged such that each mobile communication unit (2) at least in a partial area with charging sections (25) of the storage unit (3) is adapted to be assigned to precisely one said charging section (25) respectively, each said charging section (25) including one of the charging stations.

18. The output arrangement (1) as claimed in claim 17, wherein the charging device (5) is configured to resume a charging cycle for one of the mobile communication units (2), which began at a previous one of the charging stations (12).

19. The output arrangement (1) as claimed in claim 5, wherein the wireless charging includes at least one of using inductive energy transfer by electromagnetic induction or via at least one sender coil in the charging station that is adapted to excite at least one receiver coil in the mobile communication units.

20. The output arrangement (1) as claimed in claim 1, wherein the storage device (3) is formed by the return device (4), the charging device (5) and the output device (6).

21. The output arrangement (1) as claimed in claim 1, wherein the charging device (5) comprises at least one direct-current converter (14).
